(19) United States
(12) Patent Application Publication
(10) Pub. No.: US 2009/0252174 A1
(43) Pub. Date: Oct. 8, 2009

(54) MESSAGE IDENTIFICATION METHOD AND A RELAY NODE USED BY THE METHOD

(75) Inventors: Hong Cheng, Singapore (SG); Qi Jie Huang, Singapore (SG)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/295,184

(22) PCT Filed: Mar. 30, 2007
(86) PCT No.: PCT/JP2007/057710

§ 371 Date: Sep. 29, 2008

(30) Foreign Application Priority Data
Mar. 31, 2006 (JP) 2006-098150

(51) Int. Cl. H04L 12/56

(52) U.S. Cl. 370/400

(57) ABSTRACT

A technology providing a message identification method that can accurately identify a message for reserving the resources of a new path when a path change occurs in a network and the like is disclosed. According to the technology, a step of a relay node 102 that has detected a change in a data communication path including first information for differentiating a QoS reservation message from a QoS maintenance message in the QoS reservation message used to make a QoS reservation in a relay node on a new data communication path and transmitting the QoS reservation message, and a step of, when a relay node 110 that has received the QoS reservation message judges whether the relay node 110 itself is a relay node positioned at a convergence point of the QoS maintenance message and judges that the relay node 110 itself is the relay node positioned at the convergence point, identifying which message is the newest based on second information for identifying the relay node itself and the message to be received by the relay node itself, stored in a predetermined memory area in the relay node itself, and the first information included in the QoS reservation message.

### TECHNICAL FIELD

The present invention relates to a message identification method and a relay node used in the method for identifying a predetermined message transmitted in accompaniment with a change in a data communication path.

### BACKGROUND ART

In a packet switching data communication network, data traffic paths usually are not fixed. Network nodes, such as routers, decide the path of a flow based on information embedded in a data packet. The decision performed in real-time is ordinarily made based on the configuration of the network nodes, such as routing tables, and network status, such as link loads. Therefore, dynamic changes in an actual data path may occur during the lifetime of a communication session. For example, the dynamic changes may be caused by an overload of a certain link or a temporary failure of a path. To ensure Quality of Service (QoS) of the communication session, resources are required to be provided along a new data path. In addition, the resources provided along the old data paths are required to be released to improve network efficiency. In a path-coupled type of QoS management scheme, such as Resource reSerVation Protocol (RSVP: refer to Non-patent document 1) and Next Steps In Signaling (NSIS: refer to Non-patent documents 2 and 3), a QoS control signaling message is transmitted along the data path, of the session. Therefore, when the data path changes, the signaling message is required to be transmitted over the new path to establish the state and reserve necessary QoS resources.

Ordinarily, a change in the route is confined within a certain area of the network and does not affect the entire path. The change is not noticed by the application layer unless a significant change occurs in the QoS level or a packet drop occurs. Therefore, to quickly establish the QoS over the changed paths, a local repair technique is used in RSVP and NSIS. The local repair technique allows the starting point of the route change to transmit a message for setting up a new path without involving communication session end nodes. Re-establishment of the QoS can be performed quickly without burden being placed on end nodes. However, this type of signaling is subject to signaling racing problems.

After a route change, data packets including the QoS signaling message flow over a new path. The new path may be better in quality than the old path, such as by having significantly lower delays than the old path Therefore, it is highly possible that the signaling messages sent before and after the route change will arrive at the Crossover Node (CRN) out of order. The CRN is where the new path and the old path cross. In this case, the CRN may mistakenly replace the states of the new paths. To avoid this mistake, the CRN is required to distinguish the sequence of the messages. However, the messages are transmitted by different network nodes. A simple sequence number would be useless in sorting the messages. For example, a Reservation Sequence Number (RSN) used in NSIS has only local significance between adjacent peers (nodes), and thus is useless in this case since the messages arrive at the CRN from different peers. In addition, there is no way for the different network nodes to synchronize the sequence number they use. At the same time, end-to-end control sequence numbers are also useless because, as described earlier, the route change does not affect the end nodes and the local repair signaling messages are not transmitted by the end nodes.

[Patent Document 1] U.S. Pat. No. 5,235,599 “A Self-healing net work with distributed failure restoration capabilities”

[Non-Patent Document 1] Braden, R., “Resource ReS erVation Protocol (RSVP)-Version1 Functional Specification”, RFC2205, September 1997

[Non-Patent Document 2] Schulzrinne, H. and R. Han cock, “GIMPS:General Internet Messaging Protocol for Signaling”, Internet Draft draft-ietf-nsis-ntlp-07, July 2005

[Non-Patent Document 3] Bosch, S., “NSLP for Quality-of-Service Signaling”, Internet Draft draft-ietf-nsis-qos-nslp-07, July 2005

To solve this issue, a delay in the transmission of the local repair messages in RSVP is proposed. A certain amount of wait time is provided after route change to allow the network to settle down. However, this type of scheme would cause delays and losses that are not acceptable in sensitive applications, such as voice applications and real-time streaming. In this type of a solution, the possibility of a signaling race still cannot be fully eliminated. For example, when the delay is set to 10 seconds, another route change occurs in 10.1 seconds. Therefore, a more affirmative method is required.

The use of a time stamp is another method of sorting the messages. However, the time of all nodes are required to be accurately synchronized. Furthermore, in the time stamp method, the correct sequence of the messages is not necessarily reflected at all times. For example, a route change may occur on an old path at a later time. The message has a timestamp with a larger value. However, the message should actually be discarded.

There are several ways of discovering an optimal route in the network after failure or a change. For example, in Patent document 1, described below, a message broadcasted from an end node of a failed link is use to find the path to the destination that should be selected. However, the broadcast causes an overhead in the signaling. After all messages are received, assistance from the end nodes is required to make a decision. This slows the process and places a burden on the network and the end nodes.

### DISCLOSURE OF THE INVENTION

The present invention has been achieved in light of the above-described problems. An object of the present invention is to provide a message identification method and a relay node used in the method for accurately identifying a message for reserving the resources of a new path when a path change occurs in a network.

Another object of the present invention is to provide a node (a signaling aware node) that can process signaling for maintaining information of an appropriate QoS state in a communication session.

In order to achieve the above-described objects, according to the present invention, in a communication network including a second node that is a correspondent node of a first node transmitting and receiving data and a plurality of relay nodes that relay the data transmitted and received between the first node and the second node, in which a QoS reservation is made in a relay node on a data communication path between the first node and the second node, the message identification method identifies a QoS reservation message and a QoS maintenance message when a change occurs in the data communication path. The QoS reservation message is transmitted to make a QoS reservation in a relay node on a new data communication path. The QoS maintenance message is transmitted to maintain the QoS reservation in the relay node on the data communication path before the occurrence of the change. The message identification method includes a step at which, when transmitting the QoS reservation message to make the QoS reservation in the relay node on the new data communication path, a relay node that has detected the change in the data communication path includes and transmits first information used when differentiating the QoS reservation message from the QoS maintenance message. The message identification method also includes a step at which, when the relay node that has received the QoS reservation message decides that the relay node itself is a relay node positioned at a convergence point of the QoS maintenance message and the QoS reservation message, the relay node identifies which message is the newest, based on second information for identifying the relay node itself and the message to be received by the relay node itself, stored in a predetermined memory area of the relay node itself, and the first information included in the QoS reservation message. As a result of the configuration, a message for reserving the resources of the new path can be accurately identified when a path change occurs in the network.

In addition, in the message identification method of the present invention, a preferred aspect of the present invention is that the relay node positioned at the convergence point of the QoS maintenance message and the QoS reservation message decides whether to update the stored second information based on the identification result regarding which message is the newest. As a result of the configuration, appropriate processing can be performed even when a new change occurs in the data communication path.

In addition, in the message identification method of the present invention, a preferred aspect of the present invention is that the first information includes at least sequence information, history information, and distance information. The sequence information is managed by the first node and is used to identify the messages between the first node and the second node. The history information is the history information of past data communication path changes, stored in the relay node that has detected the change in the data communication path, to which identification information identifying the relay node itself that has detected the change in the data communication path is added. The distance information indicates the distance between the relay node that has detected the change in the data communication path and the first node. As a result of the configuration, the messages can be identified appropriately.

In addition, in the message identification method of the present invention, a preferred aspect of the present invention is that the second information includes at least distance information, sequence information, and history information of past data communication path changes. The distance information indicates the distance between the relay node positioned at the convergence point of the QoS maintenance message and the QoS reservation message and the first node. The sequence information is managed by the first mode and is used to identify the messages between the first node and the second node. As a result of the configuration, the messages can be identified appropriately.

In addition, in the message identification method of the present invention, a preferred aspect of the present invention is that the distance information increases every time the message is transferred. As a result of the configuration, the position of the relay node can be identified.

In addition, in the message identification method of the present invention, a preferred aspect of the present invention is that, when identifying which message is the newest, the relay node positioned at the convergence point of the QoS maintenance message and the QoS reservation message performs the identification based on the sequence information in the first information and the sequence information in the second information. When the sequence information in the first information and the sequence information in the second information are the same, the relay node performs the identification based on the history information in the first information and the history information in the second information. As a result of the configuration, whether the message is the newest message can be accurately identified.

In addition, in the message identification method of the present invention, a preferred aspect of the present invention is that the first information includes at least session identification information, flow identification information, sequence information, distance information, and information that is path change information before data communication path change, stored in a predetermined memory area of the relay node that has detected the change in the data communication path, to which path change information, including distance information indicating the distance between the relay node that has detected the change in the data communication path and the first node and information on the frequency of data communication path changes in the relay node that has detected the change in the data communication path, is added. The session identification information identifies the communication session. The flow identification information identifies the message flow. The sequence information is managed by the first node and is used to identify the messages between the first node and the second node. The distance information indicates the distance between the relay node that has detected the change in the data communication path and the first node. As a result of the configuration, the messages can be appropriately identified.

In addition, in the message identification method of the present invention, a preferred aspect of the present invention is that the second information includes at least session identification information, flow identification information, sequence information, distance information, information on the frequency of changes in the data communication path in the relay node positioned at the convergence point of the QoS maintenance message and the QoS reservation message, and path change information. The session identification information identifies the communication session. The flow identification information identifies the message flow. The sequence information is managed by the first node and is used to identify the messages between the first node and the second node. The distance information indicates the distance between the relay node positioned at the convergence point of the QoS maintenance message and the QoS reservation message and the first node. The path change information includes distance information indicating the distance between the relay node that has detected another data communication path change before the change in the data communication path and the information on the frequency of changes in the data communication path in the relay node that has detected the other data communication path change before the change. As a result of the configuration, the messages can be appropriately identified.

In addition, in the message identification method of the present invention, a preferable aspect of the present invention is that the distance information increases every time the message is transferred. As a result of the configuration, the position of the relay node can be identified.

In addition, in the message identification method of the present invention, a preferred aspect of the present invention is that, when identifying which message is the newest, the relay node that is positioned at the convergence point of the QoS maintenance message and the QoS reservation message performs the identification based on the sequence information in the first information and the sequence information in the second information. When the sequence information in the first information and the sequence information in the second information are the same, the relay node performs the identification based on the path change information in the first information and the path change information in the second information. As a result of the configuration, whether the message is the newest can be accurately identified.

In addition, according to the present invention, in a communication network including a second node that is a correspondent node of a first node transmitting and receiving data and a plurality of relay nodes that relay the data transmitted and received between the first node and the second node, in which a QoS reservation is made in a relay node on a data communication path between the first node and the second node, the relay node is used in a message identification method for identifying a QoS reservation message and a QoS maintenance message when a change occurs in the data communication path. The QoS reservation message is transmitted to make a QoS reservation in a relay node on a new data communication path. The QoS maintenance message is transmitted to maintain the QoS reservation in the relay node on the data communication path before the occurrence of the change. The relay node includes a receiving means, a storing means, a generating means, a transmitting means, a judging means, and an identifying means. The receiving means receives the messages. The storing means stores state information used to identify the relay node itself and the message to be received by the relay node itself. The generating means generates the QoS reservation message that is used to make the QoS reservation in the relay node on the new data communication path when a change occurs in the data communication path and includes the identification information used when differentiating the QoS reservation message from the QoS maintenance message. The transmitting means transmits the generated QoS reservation message over the new data communication path. The judging means judges whether the relay node itself is the relay node positioned at the convergence point of the QoS maintenance message and the QoS reservation message transmitted from another relay node. The identification means identifies which message is the newest based on the state information stored in the storing means and the identification information included in the QoS reservation message transmitted from the other relay node, when judged that the relay node itself is the relay node positioned at the convergence point of the QoS maintenance message and the QoS reservation message transmitted from the other relay node. As a result of the configuration, the message for reserving the resources of the new path can be accurately identified when the path change occurs in the network.

In addition, in the relay node of the present invention, a preferred aspect of the present invention is that the identifying means decides whether to update the state information stored in the storing means based on the identification result. As a result of the configuration, appropriate processing can be performed even when a new change occurs in the communication path.

In addition, in the relay node of the present invention, a preferred aspect of the present invention is that the state information includes at least distance information, sequence information, and history information of past data communication path changes. The distance information indicates the distance between the relay node itself and the first node. The sequence information is managed by the first node and is used to identify the messages between the first node and the second node. As a result of the configuration, the messages can be appropriately identified.

In addition, in the relay node of the present invention, a preferred aspect of the present invention is that the identification information included in the QoS reservation message includes at least sequence information, history information, and distance information. The sequence information is managed by the first node and is used to identify the messages between the first node and the second node. The history information is the history information of the past data communication path changes included in the state information to which the identification information identifying the relay node itself is added. The distance information indicates the distance between the relay node itself and the first node. As a result of the configuration, the messages can be appropriately identified.

In addition, in the relay node of the present invention, a preferred aspect of the present invention is that the distance information increases every time the message is transferred. As a result of the configuration, the position of the relay node can be identified.

In addition, in the relay node of the present invention, a preferred aspect of the present invention is that, when identifying which message is the newest, the identifying means performs identification based on the sequence information in the identification information included in the QoS reservation message transmitted from the other relay node and the sequence information in the state information in the storing means. When the sequence information in the identification information included in the QoS reservation message transmitted from the other relay node and the sequence information in the state information in the storing means are the same, the relay node performs the identification based on the history information in the identification information included in the QoS reservation message transmitted from the other relay node and the history information in the state information in the storing means. As a result of the configuration, whether the message is the newest message can be accurately identified.

In addition, in the relay node of the present invention, a preferred aspect of the present invention is that the state information includes at the least session identification information, flow identification information, sequence information, distance information, information on the frequency of changes in the data communication path in the relay node itself, and path change information. The session identification information identifies the communication session. The flow identification information identifies the message flow. The sequence information is managed by the first node and is used to identify the messages between the first node and the second node. The distance information indicates the distance between the relay node itself and the first node. The path change information includes the distance information indicating the distance between the relay node that has detected the other data communication path change before the change in the data communication path and the first node and the information on the frequency of changes in the data communication path in the relay node that has detected the other data communication path change before the change. As a result of the configuration, the messages can be appropriately identified.

In addition, in the relay node of the present invention, a preferred aspect of the present invention is that the identification information included in the QoS reservation message includes at least session identification information, flow identification information, sequence information, distance information, and information that is the path change information before the data communication path change stored in the storing means of the relay node itself to which the path change information, including the distance information indicating the distance between the relay node itself and the first node and the information on the frequency of the changes in the data communication path in the relay node itself, is added. The session identification information identifies the communication session. The flow identification information identifies the message flow. The sequence information is managed by the first node and is used to identify the messages between the first node and the second node. The distance information indicates the distance between the relay node itself and the first node. As a result of the configuration, the messages can be appropriately identified.

In addition, in the relay node of the present invention, a preferred aspect of the present invention is that the distance information increases every time the message is transferred. As a result of the configuration, the position of the relay node can be identified.

In addition, in the relay node of the present invention, a preferred aspect of the present invention is that, when identifying which message is the newest, the identifying means performs the identification based on the sequence information in the identification information included in the QoS reservation message transmitted from the other relay node and the sequence information in the state information in the storing means. When the sequence information in the identification information included in the QoS reservation message transmitted from the other relay node and the sequence information in the state information in the storing means are the same, the replay node performs the identification based on the path change information in the identification information included in the QoS reservation message transmitted from the other relay node and the path change information in the state information in the storing means. As a result of the configuration, whether the message is the newest message is accurately identified.

The message identification method and a relay node used in the method have the above-described configuration. When a path change occurs in the network, the message for reserving the resources of the new path can be accurately identified.

### BRIEF DESCRIPTION OF THE DRAWINGS

FIG. 1 is a block diagram of an example of a configuration of a communication network according to a first embodiment of the present invention;

FIG. 2 is a block diagram of an example of a configuration of a communication network at time T2 according to the first embodiment of the present invention;

FIG. 3 is a block diagram of an example of a configuration of a communication network at time T3 according to the first embodiment of the present invention;

FIG. 4 is a block diagram of an example of a configuration of a relay node according to the first embodiment of the present invention;

FIG. 5 is a diagram for explaining a RC_Node_Index_Stack in the communication network according to the first embodiment of the present invention;

FIG. 6 is a flowchart of an example of a message processing logic by a relay node (QNE) according to the first embodiment of the present invention;

FIG. 7 is a diagram for explaining a RC_Stack in a communication network according to a second embodiment of the present invention;

FIG. 8 is a flowchart of an example of a message processing logic in RCL of the relay node (QNE) according to the second embodiment of the present invention;

FIG. 9 is a flowchart of an example of a message processing logic deciding whether RC_Stack of MSG in RCL of the relay node (QNE) is newer than that of QSD, according to the second embodiment of the present invention; and

FIG. 10 is a flowchart of an example of a processing logic in SCL of the relay node (QNE) according to the second embodiment of the present invention.

### BEST MODE OF CARRYING OUT THE INVENTION

### First Embodiment

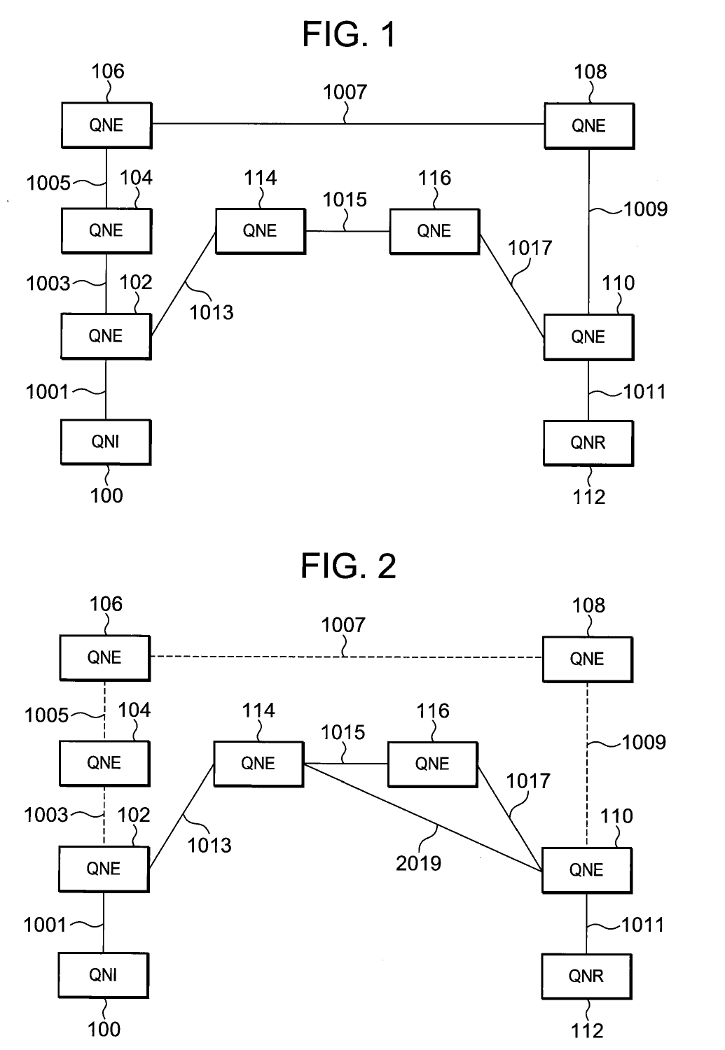

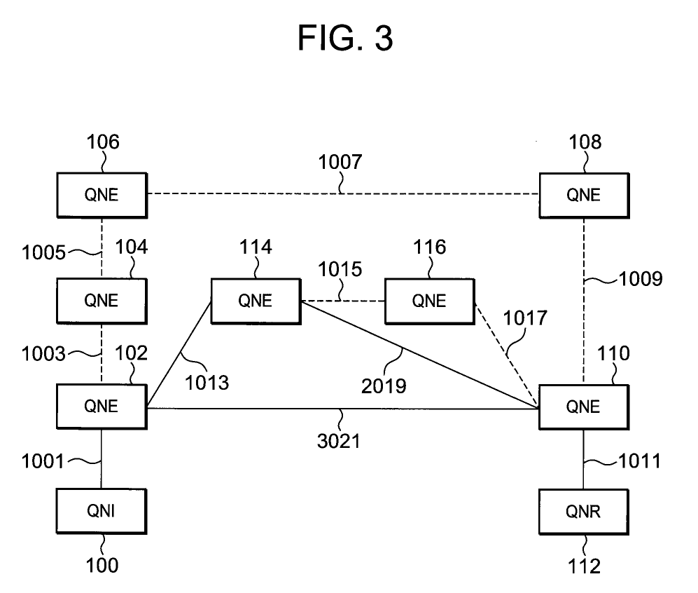

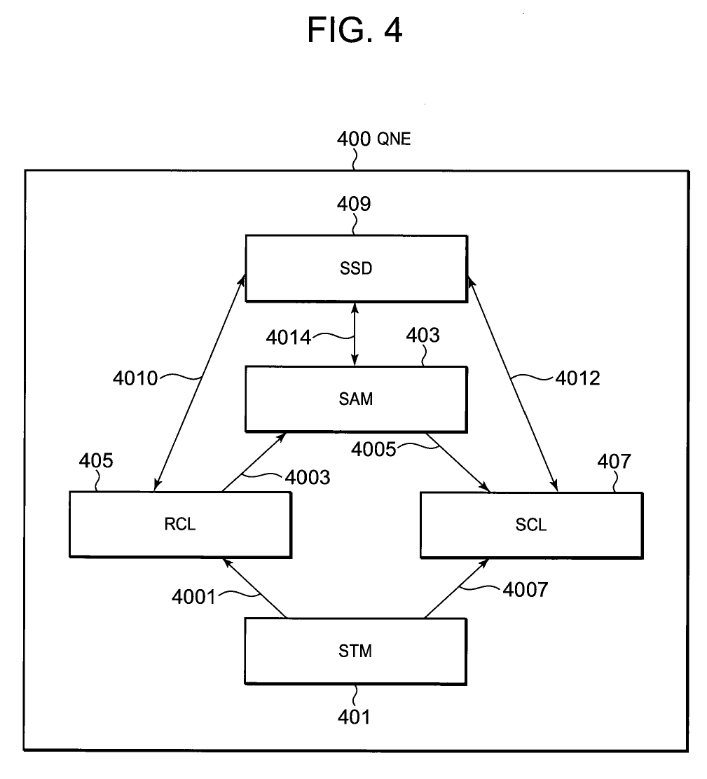

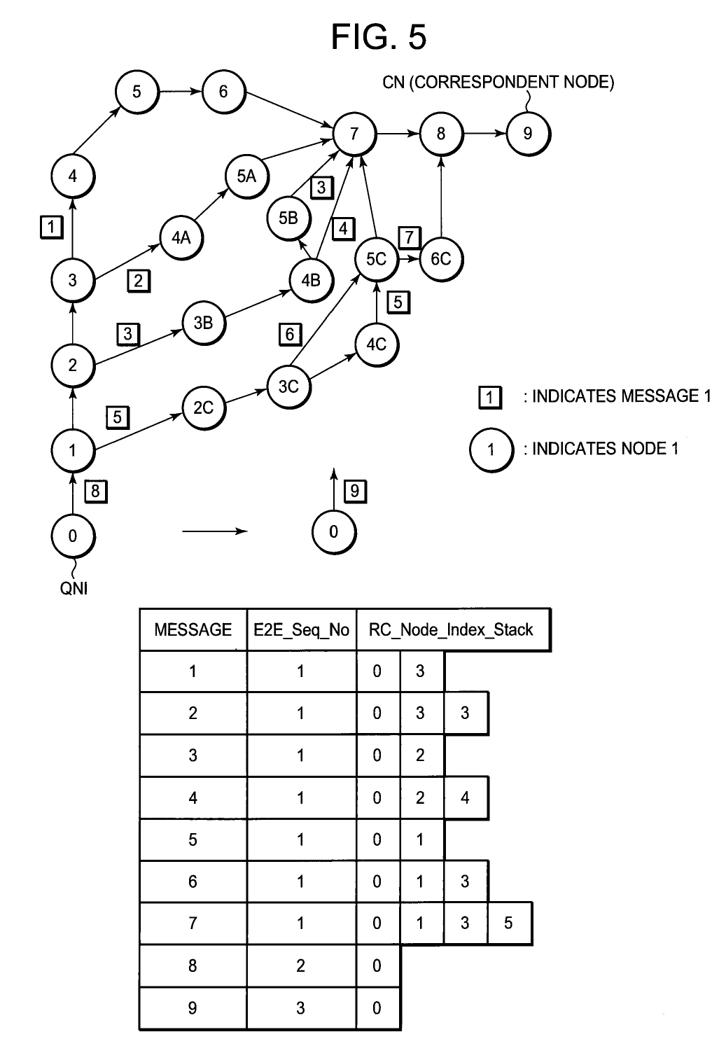

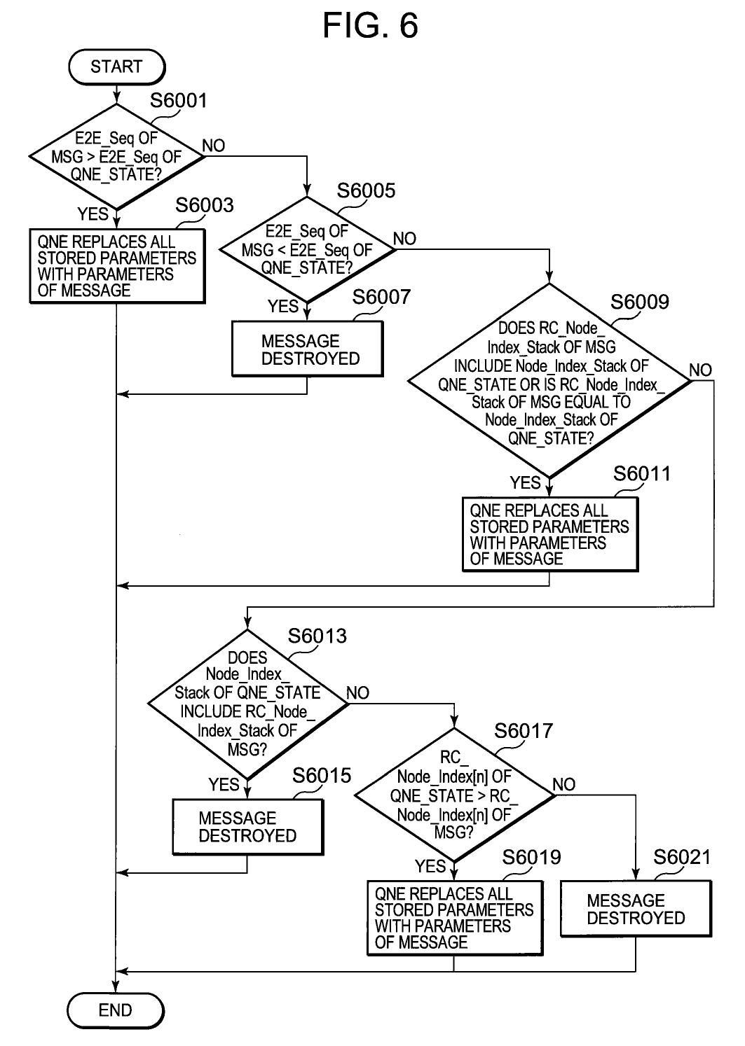

Hereinafter, a first embodiment of the present invention will be described with reference to FIG. 1 to FIG. 6. FIG. 1 is a block diagram of an example of a configuration of a communication network at time T1 according to the first embodiment of the present invention. FIG. 2 is a block diagram of an example of a configuration of the communication network at time T2 according to the first embodiment of the present invention. FIG. 3 is a block diagram of an example of a configuration of the communication network at time T3 according to the first embodiment of the present invention. FIG. 4 is a block diagram of an example of a configuration of a relay node according to the first embodiment of the present invention. FIG. 5 is a diagram for explaining an RC_Node_Index_Stack in the communication network according to the first embodiment of the present invention. FIG. 6 is a flowchart of an example of a message processing logic by a relay node (QNE) according to the first embodiment of the present invention.

Specific numbers, times, structures, and parameters are used for explanations in the descriptions hereafter to provide a complete understanding of the present invention. However, it is clear to a person skilled in the art that the present invention may be achieved without such specific details.

As shown in FIG. 1, an example of a configuration of a communication network performing a route change is shown. A QoS aware Network signaling Initiator (QNI) 100 that is a signaling end host establishes a signaling session for a data communication session with a QoS aware Network signaling Responder (QNR) 112 that is another end host. If a path-coupled type signaling scheme, such as RSVP or NSIS, is used, a signaling path is established along the data path. The initial signaling path from the QNI 100 is established to the QNR 112, via a QoS aware Network Entity (QNE) 102, a QNE 104, a QNE 106, a QNE 108, and a QNE 110. In the sequence, links involved in the communication are link 1001, link 1003, link 1005, link 1007, link 1009, and link 1011.

The data path changes during the communication session. For example, the QNE 102 performs a route change at time T1. The new path comprises of a path from the QNI 100 to the QNE 102, via the link 1001, the path from the QNE 102 to a QNE 114, via a link 1013, the path from the QNE 114 to a QNE 116, via a link 1015, the path from the QNE 116 to the QNE 110, via a link 1017, and the path from QNE 110 to QNE 112, via the link 1011. It is clear to a person skilled in the art that the route change occurs because of various reasons, such as congestion at the link 1003 or a network management policy decision. Therefore, in order to maintain the QoS, signaling over the new path is required. For example, the QNE 102 is required to transmit a signaling message, such as a message 1, over the new path to install a new state over the new path. The message is processed by each QNE along the path and reaches the QNE 110, which is a cross-over node (CRN) of the new path and the old path.

Because the network conditions may change dynamically, further changes in the data path are possible during the same communication session. An example of further changes is shown in FIG. 2. At time T2, another route change occurs at QNE 114. The new path switches from the link 1015 to a link 2019. Therefore, the new end-to-end path is a path passing through the QNI 100, the QNE 102, the QNE 114, the QNE 110, and the QNR 112. The links involved in the sequence are the link 1001, the link 1013, the link 2019, and the link 1011. Similarly, the change in the data path requires signaling from the QNE 114 for the new path to be established. The QNE 114 transmits a message 2 that is the signaling message to the QNE 110. The message 2 reaches the QNE 110 that is the CRN.

Similarly, further route changes may occur in the network after the above-described changes. FIG. 3 shows an example of a possible route change. At time T3, the QNE 102 performs another route change. The data path switches to a link 3021 in place of the link 1013. In this case, the new data path is a path that passes through the QNI 110, the QNE 102, the QNE 110, and the QNR 112. The links involved in the sequence are the link 1001, the link 3021, and the link 1011. Therefore, the QNE 102 transmits another signaling message toward the new path. For example, the QNE 102 transmits a message 3. The message 3 arrives at the QNE 110 that is the new CRN.

From the above-described router-change scenario, it is clear that the three signaling messages, the message 1, the message 2, and the message 3, are transmitted towards the QNE 110 as the results of the route changes. These messages may arrive at the QNE 110 out of sequence. For example, the message 3 traverses fewer QNE than the message 1 and, therefore, may reach the QNE 110 earlier. Therefore, appropriate information is required to be presented to the QNE 110. The QoS state can be appropriately processed if the appropriate information is presented.

An example of a configuration of a QNE supporting the first embodiment of the present invention will be described with reference to FIG. 4. A QNE 400 includes five main components, which are a Signaling Transport Module (STM) 401, a Signaling Application Module (SAM) 403, a Receiving Control Logic (RCL) 405, a Sending Control Logic (SCL) 407, and a Signaling State Database (SSD) 409. The STM 401 is related to the transfer of the signaling message. In the NSIS system, the STM 401 is a NSIS Transport Layer Protocol (NTLP) layer. The SAM 403 is an application module that processes signaling message payloads. In the NSIS system, the SAM 403 is a QoS NSIS Signaling Layer Protocol (NSLP) layer. In the following descriptions, the NSIS system is used as an example. However, it is clear to a person skilled in the art that the first embodiment of the present invention can operate in other types of signaling systems as long as similar information for control is available.

The RCL 405 identifies the sequence of the received messages. The RCL 405 guarantees that the messages generated due to the route changes are processed according to their significance. For example, the RCL 405 in the QNE 110 guarantees that the state will be correctly installed by the message 3. If the message 2 or the message 1 arrives after the message 3, the message 1 and the message 2 will be discarded. The SCL 407 inserts appropriate information into the messages. The RCL 405 in the receiving QNE 400 can correctly process the messages, as described above. The SSD 409 is a database storing all required information regarding information on signaling states and required sessions and flows. The SSD 409 is updated by the RCL 405 or the SCL 407 based on the message to be processed.

To facilitate the identification of the message sequence by the RCL 405, the respective QNE 400 is required to store extra information than in an ordinary signaling state. For example, the information can include the distance from itself to the signaling initiator of the signaling session, and an end-to-end sequence that is controlled by the signaling initiator of the signaling session. Other information, such as route change node index stack (RC_Node_Index_Stack), is also stored. It is clear to a person skilled in the art that the QNI 110, which is a special QNE, ordinarily has an empty RC_Node_Index_Stack.

The following stored information can be used as an example of the QNE 400.

### QNE_STATE:=[Own_Node_Index]

[E2E_Seq]

[Node_Index_Stack]

Here, Node_Index_Stack is [Node_Index]. Own_Node_Index is maintained by the message transport layer using a hop counter. For example, the Own_Node_Index is an integer indicating the number of IP hops between the current QNE 400 and the QNI 100. It is clear to a person skilled in the art that other types of distance counters can be used.

E2E_Seq is a sequence number maintained by the QNI 100 and is included in each transmitted message.

Node_Index_Stack includes the Own_Node_Index of all nodes on a signaling path that have experienced a route change.

At the same time, the message itself is required to include more information to help the operation. For example, the special information includes an end-to-end sequence number managed by the QNI 100 and a stack of Node_Index of the nodes on the signaling paths on which the route change has occurred.

A data structure of a special message element is as follows.

### MSG:=[E2E_Seq]

[RC_Node_Index_Stack]

Here, RC_Node_Index_Stack:=[RC_Node_Index]

E2E_Seq is copied from the QNE_STATE of the QNE 400 that transfers the message.

RC_Node_Index_Stack is copied from the Node_Index_Stack in the QNE_STATE of the QNE 400 that transfers the message.

Here, the RC_Node_Index_Stack will be described with reference to FIG. 5. For example, in a network such as that shown in FIG. 5, the E2E_Seq_No of the message “4” is “1” and the RC_Node_Index_Stack is “0, 2, 4”. The RC_Node_Index_Stack being “0, 2, 4” means that the message “4” is sent from node “0”, changed at node “2” and, furthermore, is updated at node “4 (4B)”. The first “0” in the RC_Node_Index_Stack can be omitted because it is obvious that the message will first be sent from the QNI (node “0”). In addition, because the same node may consecutively perform a route change numerous times, a message, such as message “2”, a separate value indicating “route change frequency” can be added to the message “2” and the like to avoid the same values from being aligned.

When the QNE 400 receives a message, a normal signaling check is performed. For example, in NSIS, a session ID and a flow ID are checked. The corresponding state information is retrieved from the state information stored in the QNE 400. When no state is stored in the QNE 400 and the session ID and the flow ID are correlated, this indicates that the QNE 400 is a new node on the signaling path. The new state including QNE_STATE is generated on the node, and information from the message is copied. When the session ID and the flow ID of the message is the same as those stored in the SSD 409 in the QNE 400, the MSG is compared with the QNE_STATE of the QNE 400 and checked. An example of the check operation is described in the flowchart shown in FIG. 6 hereafter.

In the judgment of whether the E2E_Seq in the MSG is greater than the E2E_Seq in the QNE_STATE (Step S6001), if the E2E_Seq in the MSG is greater than the E2E_Seq in the QNE_STATE, QNE replaces all stored parameters with the parameters of the message (Step S6003). In the judgment of whether the E2E_Seq in the MSG is less than the E2E_Seq in the QNE_STATE (Step S6005), if the E2E_Seq in the MSG is less than the E2E_Seq in the QNE_STATE, the message is destroyed (Step S6007). At the same time, when the E2E_Seq in the MSG is equal to E2E_Seq in the QNE_STATE, in the judgment of whether the RC_Node_Index_Stack in the MSG includes or is equal to the Node_Index_Stack in the QNE_STATE (Step S6009), if the RC_Node_Index_Stack in the MSG includes or is equal to the Node_Index_Stack in the QNE_STATE, the QNE replaces all stored parameters with the parameters of the message (Step S6011). In the judgment of whether the Node_Index_Stack in the QNE_STATE includes the RC_Node_Index_Stack in the MSG (Step S6013), if the Node_Index_Stack in the QNE_STATE includes the RC_Node_Index_Stack in the MSG, the message is destroyed (Step S6015). At the same time, if there is no inclusive relationship between the Node_Index_Stack in the QNE_STATE and the RC_Node_Index_Stack in the MSG, the QNE searches for the entry in the Node_Index_Stack in the QNE_STATE that starts to differ from the RC_Node_Index_Stack in the MSG. For an n, in which the Node_Index_Stack[n] in the QNE_STATE is not equal to the RC_Node_Index_Stack[n] in the MSG, in a judgment of whether the RC_Node_Index[n] in the QNE_STATE is greater than the RC_Node_Index[n] in the MSG (Step S6017), if the RC_Node_Index[n] in the QNE_STATE is greater than the RC_Node_Index[n] in the MSG, the QNE replaces all stored parameters with the parameters of the message (Step S6019). If the RC_Node_Index[n] in the QNE_STATE is not greater than the RC_Node_Index[n] in the MSG, the message is destroyed (Step S6021).

In the operation, “the QNE replaces all stored parameters with the parameters of the message” means that the QNE 400 uses state management, for example, the RC_Node_Index_Stack in the MSG in place of the Node_Index_Stack in the QNE_STATE, and updates the E2E_Seq in the QNE_STATE to the E2E_Seq in the MSG. The QNE 400 not only updates the Own_Node_Index in the QNE_STATE using the hop counter information included in the message, but also uses the information in the message received in a normal signaling application.

In the above-described logic steps, the comparison operation for “include” or “equal to” means that, in the same sequence, all entries of the operand following the operator can be found in the operand before the operator. In other words, when the Node_Index_Stack in the QNE_STATE includes the RC_Node_Index_Stack in the MSG, this indicates that the number of elements in the Node_Index_Stack in the QNE_STATE is m elements and the number of elements in the RC_Node_Index_Stack is n elements (m and n are natural numbers), and m is greater than n. The first value to the nth value of the Node_Index_Stack in the QNE_STATE completely matches the first value to the nth value of the RC_Node_Index_Stack. In other words, for example, when the Node_Index_Stack in the QNE_STATE is “1, 2, 4” and the RC_Node_Index_Stack in the MSG is “1, 2”, the Node_Index_Stack in the QNE_STATE includes the RC_Node_Index_Stack in the MSG. For example, when the Node_Index_Stack in the QNE_STATE is “1, 1, 2, 4” and the RC_Node_Index_Stack in the MSG is “1, 2”, the Node_Index_Stack in the QNE_STATE does not include the RC_Node_Index_Stack in the MSG. A similar definition can be applied when the RC_Node_Index_Stack in the MSG includes the Node_Index_Stack in the QNE_STATE. It is clear to a person skilled in the art that, in actual practice, the comparison of “include” or “equal to” is a part of an operation for identifying the entries of two operands, such as the Node_Index_Stack in the QNE_STATE and the RC_Node_Index_Stack in the MSG, that are the first to be not matching.

In the operation, upon noticing the route change in the signaling session, the QNE 400 adds its own index, for example the Own_Node_Index in the QNE_STATE to the top of the Node_Index_Stack in the QNE_STATE. For example, the QNE 400 discovers the route change when transmitting or transferring the message. In this case, the QNE 400 is first required to update the Node_Index_Stack in the QNE_STATE and copies the Node_Index_Stack in the QNE_STATE to the RC_Node_Index_Stack in the MSG before transmitting or transferring the message.

### Second Embodiment

An alternative solution to the first embodiment will be described below. It is clear to a person skilled in the art that both solutions are achieved based on the same principle of the present invention.

In order to perform a message processing judgment at RCL 405, a number of special information elements are required to be combined, in addition to ordinary signaling control elements, such as NSIS flow identifiers and session identifiers. An example of the message elements used in the NSIS system are shown below.

### Message:=[Session ID]

[Flow ID]

[E2E_Seq_No]

[Hop count]

[RC_Stack:=[RC_Node_Index, RC_Counter]

[Additional NSIS data]

The session ID and the flow ID are equivalent to the session ID and the flow ID used in an ordinary NSIS signaling message. The session ID and the flow ID indicate special sessions and flows related to the current message.

The E2E_Seq_No is the end-to-end sequence number managed by the QNI 100. When there is a mobility event, such as a change in a mobility connection point, the QNI 100 increases the value of the E2E_Seq_No. The value is transmitted along the signaling path toward the QNR 112. The QNI 100 can frequently decide the changes in the E2E_Seq_No. For example, if the QNI 100 wants to change the current state of the QoS reservation, the QNI 100 transmits a new signaling message having a new E2E_Seq_No along the signaling path toward the QNR 112. It is clear to a person skilled in the art that the QNI 100 changes the E2E_Seq_No as a localized policy. This does not affect the principle of the present invention. As described hereafter, it is assumed that every time the QNI 100 increases the value of the E2E_Seq_No every time a new E2E_Seq_No is transmitted. It is clear to a person skilled in the art that this is not a requirement. The value of the E2E_Seq_No can also be managed using other methods, such as by decreasing the value. The management method does not affect the principle of the present invention as long as each QNE performs identification using the value. For example, the QNE 102 to QNE 116, including the QNR 112, can identify the E2E_Seq_No transmitted later by the QNI 100.

The hop counter is used when the QNE 400 that has received the message calculates the distance from the QNI 100 on the current signaling path. In other words, the message includes the value of the distance to the QNE 400. As described hereafter, the hop counter uses an integer format and is incremented for every hop. This is to facilitate understanding. It is clear that in actual practice, the hop counter can use other formats and the increment can be another value that does not affect the principle of the present invention.

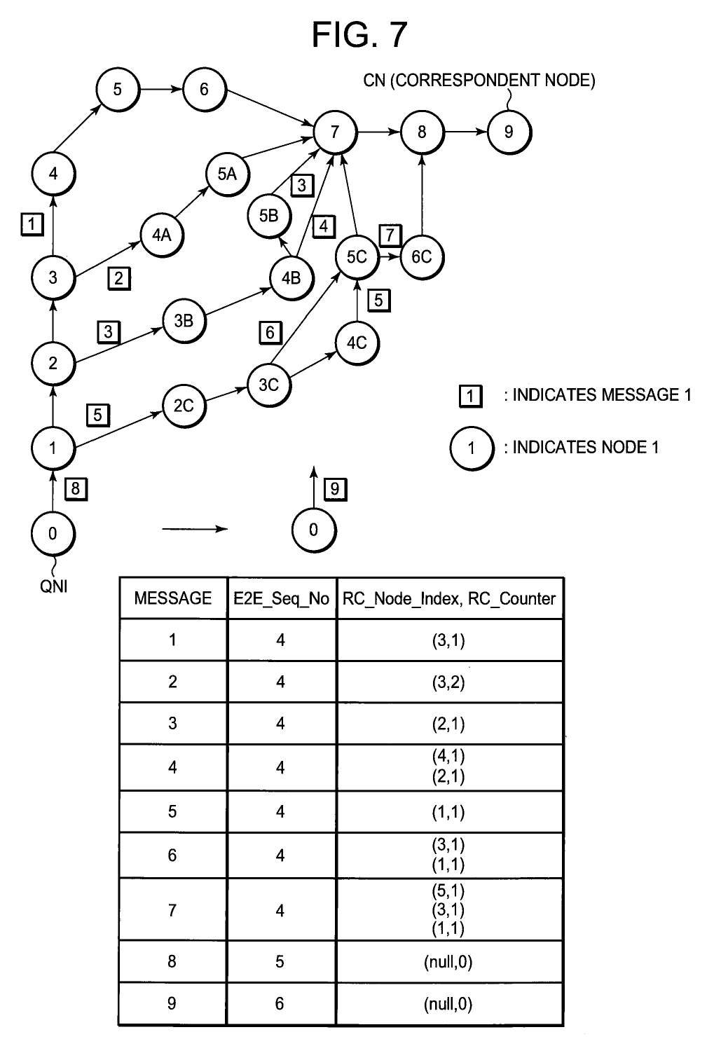

The RC_Stack within the message is a composite element. The RC_Stack can include two entries, “RC_Node_Index” and “RC_Counter”. An example of the RC_Stack is shown in FIG. 7. In a network such as that shown in FIG. 7, for example, in message “3”, the E2E_Seq_No is “4”, and the RC_Stack is “(2,1)”. In other words, this indicates that the message “3” is a message on a path in which a path change has occurred once at node “2” which is two hops from the QNI. The message “4” is a message in which a path change has occurred at node “4B”, of which the RC_Stack is the RC_Stack[(2,1)] before the path change to which the RC_Stack[(4,1)] is added. In the example, the message sent from QNI is handled as a special message. The “RC_Node_Index” of the QNI is “null” and the “RC_Node_Index” and the “RC_Counter” indicating that the message has been sent from QNI are omitted. When the QNE 400, such as the QNE 102, acknowledges a route change, the QNE 400 inserts an entry into the top of the RC_Stack and sends the message. The value of the RC_Node_Index is the distance from the transmitting QNE 400 to the QNI 100. The RC_Counter is a value that is locally managed and is related to the number of times the route changes have occurred in the QNE 400 transmitting the message. For example, in the above-described FIG. 1, 1 is provided in the RC_Node_Index and 1 is provided in the RC_Counter at QNE 102 at time T1. In the above-described FIG. 3, 1 is provided in the RC_Node_Index and 2 is provided in the RC_Counter at time T3.

The message sent by the QNI 100 should always have the special RC_Node_Index and RC_Counter values. Ordinarily, the change at the QNI 100 results in a change in the flow ID or a new E2E_Seq_No. Therefore, the RC_Stack is not necessarily required in the message processing. However, for the integrality of the message format, an entry having the values RC_Node_Index:=NULL and RC_Counter:=0 is used. Here, NULL is a value that is not used by an ordinary QNE 400 to indicate distance. For example, if the format is used in the RC_Node_Index, NULL is the maximum value of a 16-bit integer. It is clear to anyone that the use of the value simplifies the algorithm description. In actual practice, NULL is a special value recognized by the QNE 400.

The additional NSIS data has header information used for transmission control of an ordinary NSIS message and a payload used for NSIS signaling. It is clear to anyone that the use of NSIS herein is for the purpose of explanation. Other types of signaling schemes, such as RSVP, can be used here. In this case, minor modifications in the message format, such as eliminating the flow ID, are required. However, this does not affect the principle of the present invention.

When the QNE 400 receives the message via the STM 401, the QNE 400 passes the message to the RCL 405 via an interface 4001. In NSIS, the STM 401 is the NTLP layer that passes the NSIS message received from another node. After the decision, the NSIS message becomes the QoS NSLP message and is passed toward the QoS NSLP layer, such as the SAM 403, via the API with the session ID, the flow ID, and the like. The RCL 405 receives the message before the NSLP performs processing. Then, the RCL 405 decides whether the message should be transferred to the SAM 403 via an interface 4003 or destroyed.

When the message is judged to be new and is being processed, the RCL 405 passes the message toward the SAM 403. At the same time, the RCL 405 generates a state on the QNE 400. The state is stored in the SSD 409 via an interface 4010 with other signaling application states. The state is useful when identifying the newness of the messages subsequently received by the QNE 400. An example of a possible format used for state storage is as follows:

### QNE State:=[Session ID]

[Flow ID]

[E2E_Seq_No]

[Own_Node_Index]

[Local_RC_Counter]

[RC_Stack:=[RC_Node_Index, RC_Counter]]

The session ID and the flow ID are identifiers used to indicate the session and the flow. The format is the same as that used within the signaling message. In NSIS, the identifiers are the session ID and the flow ID.

The E2E_Seq_No has the same format as that in the signaling message. The value of the E2E_Seq_No held by the last newest message to be passed from the RCL 405 to the SAM 403 is stored.

The Own_Node_Index is used to store the distance from the QNI 100 to the current QNE 400. The Own_Node_Index is obtained through the hop counter of the last newest message passed from the RCL 405 to the SAM 403. For example, in the simplest instance, the Own_Node_Index is obtained by adding 1 to the hop counter.

The Local_RC_Counter is a value indicating the number of route changes that have occurred in the current QNE 400. When the route change is detected, for example, when the messages of the same flow flow to a differing signaling peer, the Local_RC_Counter is updated by the SCL 407. The value is reset by the RCL 405 when the E2E_Seq_No is updated by the received signaling message.

The RC_Stack has the same format as that in the signaling message. The RC_Stack is obtained from the last newest message passed from the RCL 405 to the SAM 403.

The SSD 409 stores not only listed information, but also other information in an ordinary signaling operation. For example, in NSIS, the identification information of the previous hop peer (previous hop node) and the identification information of the subsequent hop peer (subsequent hop node) are correlated with the same session ID and flow ID and stored in the SSD 409. This is useful when the QNE 400 decides whether there is a change in the route. It is obvious that other signaling scheme may use different method to monitor and manage the peer relationship. As long as the peer relationship can be correctly identified, the present invention operates without significant modifications.

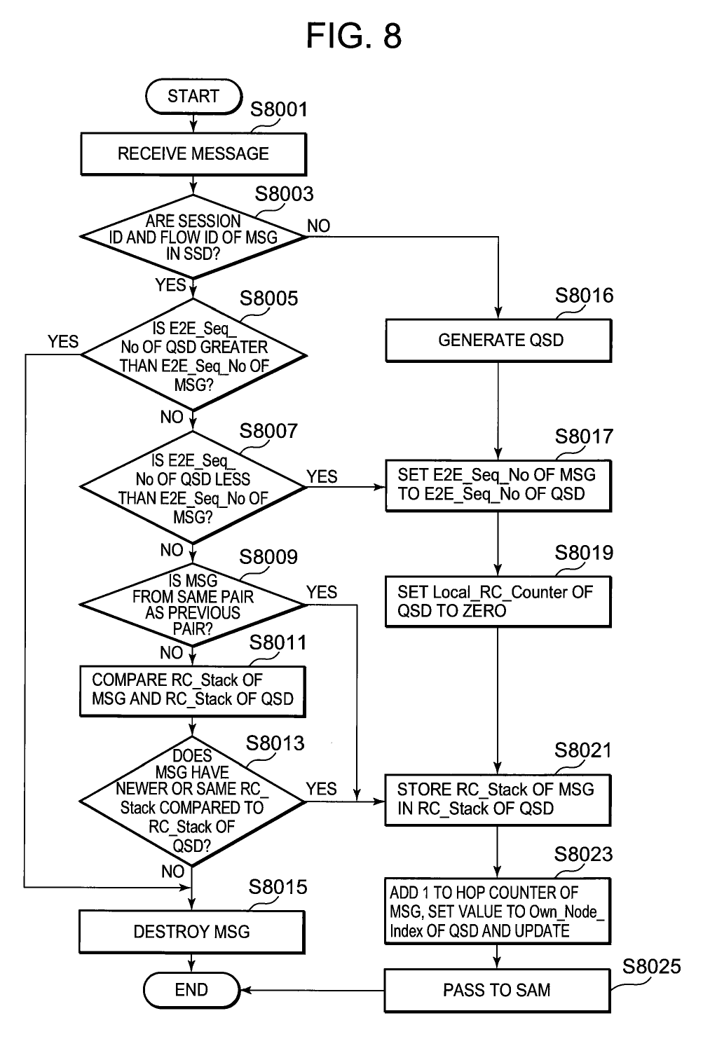

An example of a message processing logic used in the RCL will be described with reference to FIG. 8. In order to facilitate understanding, it is assumed that the STM 401 passes the received message MSG toward the RCL 405 via the interface 4001. Information, such as the identifier of the QNE of the peer sending the message, is passed. The MSG is assumed to include the following elements.

MSG:={session ID, flow ID, E2E_Seq_No, hop counter, RC_Stack[m]:={(RC_Node_Index, RC_Counter) . . . }, additional NSIS data}

m is an integer number indicating the number of entries in the RC_Stack of the message example MSG. m is not zero.

It is assumed that the SSD 409 stores the states related to the special session ID and flow ID.

QNE STATE Data (QSD):={session ID, flow ID, E2E_Seq_No, Own_Node_Index, Local RC_Counter, RC_Stack[k]:={(RC_Node_Index, RC_Counter) . . . }}

k is an integer number indicating the number of entries present in the RC_Stack of the QSD. k is not zero.

As shown in FIG. 8, when the RCL 405 receives the message (Step S8001), the RCL 405 checks whether values, such as the session ID and the flow ID of the MSG, are in the SSD 409 (Step S8003). When the session ID and the flow ID of the corresponding QSD is in the QSD, the RCL 405 compares the E2E_Seq_No of the MSG and the QSD (Step S8005). When the E2E_Seq_No of the QSD includes a value larger than the E2E_Seq_No of the MSG, the message is judged to be old. Therefore, the message is destroyed (Step S8015). The message is not passed to the SAM 403. Otherwise, the RCL 405 checks whether the E2E_Seq_No of the QSD is smaller than the E2E_Seq_No of the MSG (Step S8007). If the E2E_Seq_No of the QSD is smaller than the E2E_Seq_No of the MSG, the message is indicated to be newer. If this is true, the message is processed. The RCL 405 updates the E2E_Seq_No of the QSD by setting the E2E_Seq_No of the MSG (Step S8017). Then, the RCL 405 sets the Local_RC_Counter of the QSD to zero (Step S8019). At this time, the RCL 405 stores the RC_Stack of the MSG in the RC_Stack of the QSD (Step S8021). In addition, the RCL 405 updates the value of the distance of the QNE 400 by adding 1 to the hop counter of the MSG and setting the value in the Own_Node_Index of the QSD (Step S8023). Subsequently, the MSG and the payload are passed from the RCL 405 to the Sam 403 via the interface 4003 (Step S8025).

When the RCL 405 judges that the E2E_Seq_No of the QSD is not smaller than the E2E_Seq_No of the MSG at Step S8007, this means, in other words, that the E2E_Seq_No of the QSD and the E2E_Seq_No of the MSG are the same value. Therefore, the RCL 405 checks whether the MSG has been received from the same peer of QNE as a previous message having the same session ID and flow ID (Step S8009). In the NSIS system, the check is performed by a comparison of the peer of identifiers passed and stored by the NTLP layer. Differing methods are used in other systems. If the MSG is from the same peer, this indicates that the current QNE is not the CRN. Information can be safely copied from the MSG. Therefore, the RCL 405 proceeds to Step S8021 as shown in FIG. 8.

When the RCL 405 judges that the MSG is from a different peer QNE at Step S8009, this indicates that the node is the CRN. Therefore, the RCL 405 is required to compare the RC_Stack of the MSG and the RC_Stack of the QSD (Step S8011). Then, the RCL 405 sees whether the MSG has a newer or the same RC_Stack compared with the RC_Stack of the QSD (Step S8013). If the RC_Stack of the MSG and the QSD are the same, the RCL 405 can presume that the MSG is a new message or an updated message. The RCL 405 passes the MSG to the SAM 403 for processing. Therefore, the RCL 405 proceeds to Step S8021 as shown in FIG. 8.

When the RCL 405 judges that the MSG has an old RC_Stack at Step S8013, the RCL 405 destroys the MSG (Step S8015).

When the RCL 405 judges that the session is new, for example, no QSD having a corresponding session ID and flow ID are present in the SSD 409, at Step S8003, the RCL 405 generates a QSD (Step S8016). The RCL 405 updates all states of the QSD by proceeding to Step S8017. In this case, the MSG is a new message and is passed to the SAM 403 for processing.

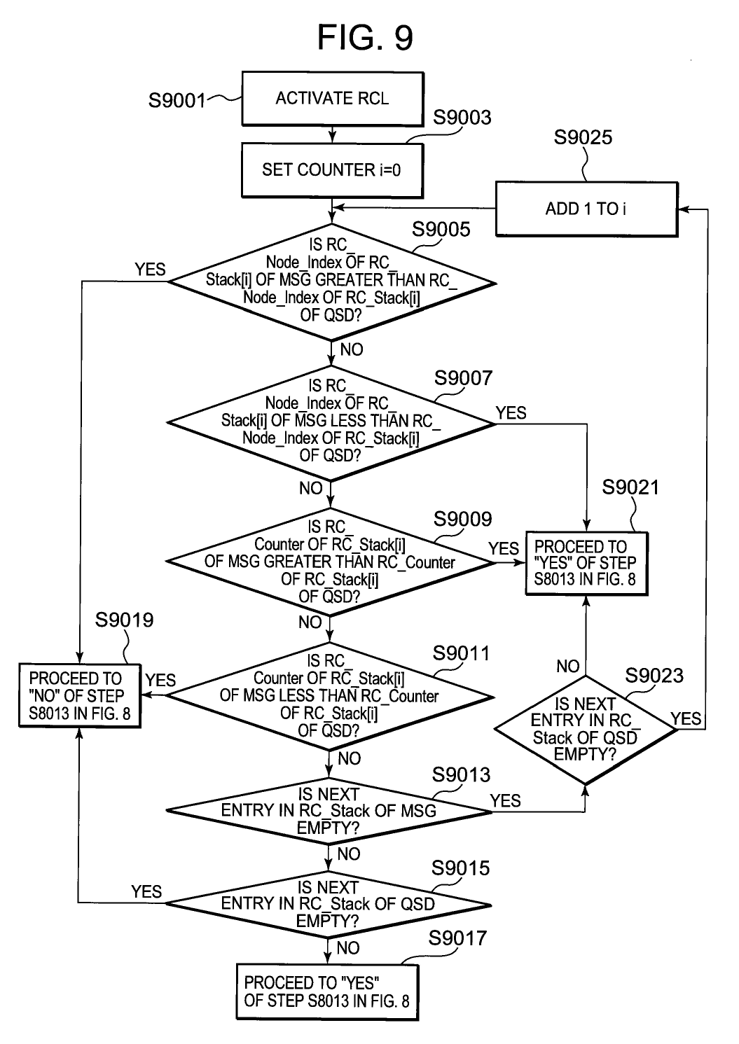

An example of a possible logic used in the RCL to decide whether the RC_Stack of the MSG is newer than that of the QSD will be described with reference to FIG. 9. Here, the RC_Stack of the MSG and the QSD are in an array format. The first entry is indicated as RC_Stack [0]. Other formats can be used as long as the principle of the present invention is not affected. For example, the index can start at a fixed number and run downward.

First, the RCL 405 is activated to obtain the first entry in the RC_Stack of the MSG and the first entry in the RC_Stack of the QSD (Step S9001). This is achieved by the counter being set to i=0 (Step S9003). The RCL 405 compares whether the RC_Node_Index of the RC_Stack[i] of the MSG is greater than the RC_Node_Index of the RC_Stack[i] of the QSD (Step S9005). When the RC_Node_Index of the RC_Stack[i] of the MSG is greater, this indicates that the MSG has an old RC_Stack. The RCL 405 proceeds to “NO” at Step S8013 shown in FIG. 8. At the same time, when the RC_Node_Index of the RC_Stack[i] of the MSG is smaller, the RCL 405 compares whether the RC_Node_Index of the RC_Stack[i] of the MSG is smaller than the RC_Node_Index of the RC_Stack[i] of the QSD (Step S9007). When the RC_Node_Index of the RC_Stack[i] of the MSG is smaller, this indicates that the MSG has a newer RC_Stack[i]. The RCL 405 proceeds to “YES” at Step S8013 shown in FIG. 8 (Step S9021).

In the comparison result at Step S9007, when the RC_Node_Index of the RC_Stack[i] of the MSG is not smaller, the RCL 405 checks whether the RC_Counter of the RC_Stack[i] of the MSG is larger than the RC_Counter of the RC_Stack[i] of the QSD (Step S9009). If the RC_Counter of the RC_Stack[i] of the MSG is larger, this indicates that the MSG has a newer RC_Stack. When the RC_Counter of the RC_Stack[i] of the MSG is larger, the RCL 405 proceeds to Step S9021 and proceeds to “YES” at Step S8013 shown in FIG. 8.

When judged that the RC_Counter of the RC_Stack[i] of the MSG is smaller at Step S9009, the RCL 405 checks whether the RC_Counter of the RC_Stack[i] of the MSG is smaller than the RC_Counter of the RC_Stack[i] of the QSD (Step S9011). If the RC_Counter of the RC_Stack[i] of the MSG is smaller, this indicates that the MSG has an older RC_Stack. When the RC_Counter of the RC_Stack[i] of the MSG is smaller, the RCL 405 proceeds to Step S9019 and proceeds to “NO” at Step S8013 shown in FIG. 8.

At the same time, when the RC_Counter of the RC_Stack[i] of the MSG is not smaller, the RCL 405 checks whether the next entry in the RC_Stack of the MSG is empty (not existing) (Step S9013). When the entry is empty, this indicates that the MSG.RC_Stack[i+1]=null. The RCL 405 further checks whether the next entry is empty (not existing) (Step S9015). When the entry is empty, this indicates that the QSD.RC_Stack[i+1]=null. This indicates that the MSG and the QSD have the same RC_Stack. The RCL 405 proceeds to “YES” at Step S8013 shown in FIG. 8 (Step S9017).

When there is a next entry in the RC_Stack of QSD at Step S9015, this indicates that QSD.RC_Stack[i+1]=null is false. This indicates that the MSG has an older RC_Stack. Therefore, the RCL 405 proceeds to Step S9019 and proceeds to “NO” at Step S8013 shown in FIG. 8.

When there is a next entry in the RC_Stack of the MSG or, in other words, the MSG.RC_Stack[i+1]=null is false, at Step S9013, the RCL 405 further checks whether the next entry in the RC_Stack of the QSD is empty (not existing) (Step S9023). When the next entry in the RC_Stack of the QSD is empty, this indicates that the MSG has a newer RC_Stack. Therefore, the RCL 405 proceeds to “YES” at Step S8013 shown in FIG. 8. However, when there is the next entry in the RC_Stack of the QSD or, in other words, the QSD.RC_Stack[i+1]=null is false, at Step S9023, the RCL 405 continues the comparison by extracting a new entry from both the RC_Stack of the MSG and the RC_Stack of the QSD. This is achieved by 1 being added to i (Step S9025). Subsequently, the RCL 405 proceeds to Step S9005 and repeats the comparison step. The comparison process is performed until one or both of the RC_Stack of MSG and the RC_Stack of QSD are exhausted.

After the SAM 403 processes the message, the SAM 403 decides whether to transfer the message or to further send a new message toward the QNR 112. The SAM 403 instructs the SCL 407 to send a message, via the interface 4005. The SCL 407 generates information required to be embedded in the message. For example, the SCL 407 of the QNE 102 and that of the QNE 114 insert information in a message for indicating a route change. When appropriate information is inserted, the SCL 407 transfers the message to the STM 401, such as the NTLP layer in the NSIS system.

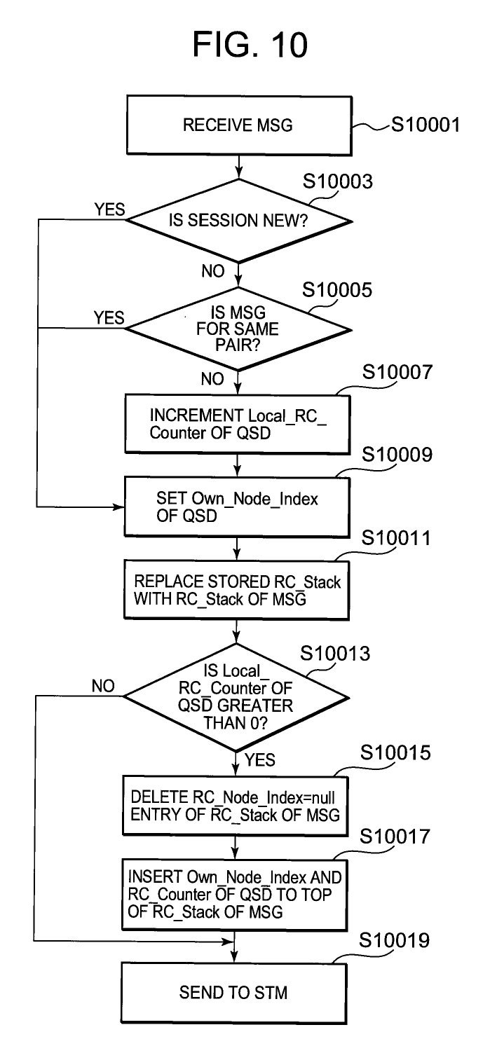

An example of a possible logic used by the SCL 407 that manages the information for the messages will be described with reference to FIG. 10. This logic is used by the SCL 407 of all QNE, for example, QNE 102 to QNE 116, including QNR 112 and excluding QNI 100. When the SCL 407 receives the MSG as a message from the SAM 403 (Step S10001), the SCL 407 checks whether this is a new session (Step S10003). For example, the SCL 407 checks whether there is a record of a message sent to the next hop peer on the signaling path by a certain QSD having a session ID and a flow ID present in the SSD 409. If the session is not new, the SCL 407 checks whether the message is for the same peer (Step S10005). In NSIS, this is identified by the identifiers of the same peer. When the message is transmitted to the different peer, this indicates that a route change has occurred in the QNE. Therefore, the SCL 407 increments the Local_RC_Counter of the QSD (Step S10007). Then, the SCL 407 sets the hop counter of the MSG to the value of the distance to the QNI 100. For example, the SCL 407 sets the Own_Node_Index of the QSD (Step S10009). The SCL 407 switches the RC_Stack stored as a result of RC_Stack of MSG=RC_Stack of QSD with that of the message (Step S10011).

Subsequently, the SCL 407 checks whether the Local_RC_Counter of the QSD is greater than 0 (Step S10013). When the Local_RC_Counter of the QSD is greater than 0 or, in other words, when the QNE has performed a route change, the SCL 407 first deletes the RC_Node_Index=null entry within the RC_Stack of the MSG (Step S10015). The SCL 407 inserts the Own_Node_Index and the RC_Counter of the QSD in the top of the RC_Stack of the MSG as the RC_Node_Index and the RC_Counter (Step S10017). The SCL 407 passes the MSG to the STM 401, and the SCL 407 transfer the next hop peer.

When the SCL 407 judges that the MSG is a new session, for example, the message has never been transmitted to the next hop peer on the signaling path, at Step S10003, the SCL 407 proceeds to Step S10009 and updates the content of the MSG.

When the SCL 407 judges that the next hop peer receives the message having the same session ID and flow ID that has previously been transmitted at Step S10005, the SCL 407 proceeds to Step S10009 and updates the content of the MSG.

When the Local_RC_Counter of the QSD is not greater than 0 at Step S10013 or, in other words, a route change has not occurred in the QNE, the SCL 407 directly proceeds to Step S10019.

As described above, the logic shown in FIG. 10 is not appropriate for the QNI 100. QNI 100 is not required to perform all checks. When the QNI 100 needs to transmit a message, the E2E_Seq_No of the MSG is set, the hop counter of the MSG is set to equal 0, and the MSG.RC_Stack={null,0} at all times.

With reference to FIG. 1, the QNE 102 has the QSD of the following values prior to time T1: QSD[QNE 102]={session ID, flow ID, E2E_Seq_No, 1, 0, [null,0]}.

At time T1, the value of the QSD changes to QSD[QNE 102]={session ID, flow ID, E2E_Seq_No, 1, 1, [null,0]}. Therefore, the message 1 has the following values: message 1={session ID, flow ID, E2E_Seq_no, 1, 1, additional NSIS data}.

Therefore, the QSD of QNE 114 is updated as follows, namely: QSD[QNE 114]={session ID, flow ID, E2E_Seq_No, 2, 0, [1,1]}.

With reference to FIG. 2, when a route change occurs in the QNE 114 at time T2, the values of the QSD changes to QSD[QNE 114]={session ID, flow ID, E2E_Seq_No, 2, 1, [1,1]}. Therefore, the message 2 has the following values: message 2={session ID, flow ID, E2E_Seq_No, 1, [1,2], additional NSIS data}.

With reference to FIG. 3, when a route change occurs in the QNE 102 at time T3, the values of the QSD changes to QSD[QNE 112]={session ID, flow ID, E2E_Seq_No, 1, 2, [null,0]}. In this case, the message 3 has the following values: message 3={session ID, flow ID, E2E_Seq_No, 1, [1,2], additional NSIS data}.

With reference to FIG. 8 to FIG. 10, it is clear that the messages reach CRN and QNE 110 regardless of sequence and the sequence is correctly identified.

### Third Embodiment

As described above, the message format being used is for the purpose of explanation. In actual practice, the formats of the message and the QSD are simplified. For example, the QNI 100 can use the Local_RC_Counter to maintain the sequence number used in the signaling message, such as E2E_Seq_No. In this case, the Local_RC_Counter of the QNI 100 does not affect the route change. On the other hand, the Local_RC_Counter affects the sequence number that is to be used in the signaling message. Therefore, the message has the following format:

Message:=[session ID]

[flow ID]

[hop counter]

[RC_Stack:={0, QNI.Local_RC_Counter],

[RC_Node_Index, RC_Counter]}

[additional NSIS data]

In this case, it is clear that the QNI 100 always receives a message having [0,QNI.Local_RC_Counter] in the RC_Stack entry. Here, the QNI.Local_RC_Counter is the same as the E2E_Seq_No described in the second embodiment.

The format of the QSD changes as a result of this change. For example, the element of the E2E_Seq_No is eliminated.

It is clear that the above-described version does not affect the logic used in the RCL 405 and the SCL 407. Therefore, the logics shown in FIG. 8 to FIG. 10 are also applied. The E2E_Seq_No is merely changed to the RC_Stack[0].RC_Counter.

### Fourth Embodiment

The logic shown in FIG. 9 shows only a method for comparing the RC_Stack. The logic has number of guidelines within the sequence. The message generated from a route change occurring in a QNE that is closer to the QNI 100 is selected. In the same QNE, the message generated by the later route change, for example, having the larger RC_Counter, is selected. When the above two are the same, the message having a larger number of route change nodes on the path is selected. In actual practice, the above-described guidelines do not affect the principle of the present invention and have other optimum methods.

### Fifth Embodiment

In the present invention, the QNE obtains the distance from the QNI 100 though the hop counter embedded in the signaling message. The QNE can use other methods to obtain the information. For example, the QNE uses geographic information, network topology for calculating the distance, and the like. The QNE can also have information regarding the distance in advance. It is clear that these methods do not affect the principle of the present invention.

Each functional block used in the explanations of each above-described embodiment is actualized as a large-scale integration (LSI), which is typically an integrated circuit. The functional blocks can be formed into individual chips or formed into one chip including a portion or all of the functional blocks. Here, this is referred to as the LSI. However, depending on the degree of integration, it can be referred to as an integrated circuit (IC), a system LSI, a super LSI, or an ultra LSI. In addition, the method used to create the integrated circuit is not limited to the LSI. The integrated circuit can also be actualized by a dedicated circuit or a general purpose processor. After LSI production, a Field Programmable Gate Array (FPGA) that is programmable or a reconfigurable processor in which connections and settings of the circuit cells within the LSI can be reconfigured can also be used. Furthermore, if a technology for creating the integrated circuit that can replace the LSI is introduced through the development of semiconductor technology or from another technology, integration of the functional blocks can naturally be performed using the technology. For example, the application of biotechnology is a possibility.

### Sixth Embodiment

In certain deployment environments, the signaling path and data path may go through several address boundaries. For example, it is possible that two communications ends, e.g. QNI (100) and QNR (112) both being mobile nodes are communicating via their respective Home Agents of Mobile IPv6. In this case, there will be address changes to the transport layer, e.g. IP header addresses. It results in different Flow IDs being used for different sections of the path. Since the relative location of the address boundaries could be arbitrary, different sections of the end-to-end path may overlap. In this case, a QNE on the overlapped path may receive signaling messages for the same session from different directions.

In order to deal with such a scenario, the present invention provides a means for the layered “hop counter” to be carried in the signaling message when an address domain entry point is crossed. For example, an address domain entry point, e.g. Home Agent of QNR (112), places a new “hop counter” stacked on top of the original “hop counter” in the signaling message. The new “hop counter” value is set to zero at the address boundary.

When a normal QNE, i.e. non address boundary, on the signaling path receives the message, it only updates the topmost “hop counter” value, as described in the previous embodiments. At the same time, when the QNE sees more than one “hop counter” in the stack, it stores the number of the layers in the “hop counter” stack.

When the QNE receives a message of the same Session ID but different Flow ID, it will first check if the number of layers in the “hop counter” stack is the same as the stored value. If they are the same, the QNE then checks other criteria to decide if it is the crossover node for this session, e.g. direction of the signaling message is upstream or downstream, if the REPLACE flag is set in the NSLP layer header, etc.

In the above check, if the QNE finds that the number of layers in the “hop counter” stack is different as the stored value, it will decide that it is not a CRN, and will carry out the instruction indicated by the signaling message, e.g. reserve the network resources to support a specified QoS specification.

At the exit point of an address domain, the topmost entry of the “hop counter” stack is removed, and the update is done to the new topmost “hop counter” entry. With this, the hop count value on each of the QNE would correctly reflect its distance to the signaling starting point inside the same address domain, and thus the invention described in the previous embodiments could still be utilized correctly.

### Seventh Embodiment

In case of the signaling message goes through an aggregation domain or load balancing domain, similar problem as described in Sixth Embodiment maybe also apply. Therefore, the entry point of these domains should be configured to behave similarly as the address boundaries. For example, at the aggregation point, a new “hop counter” entry should be stacked onto that of the original one in the signaling message. And, at the deaggregation point, the topmost “hop counter” entry of the signaling message should be removed.

Similarly, at the load balancing initiating point, the new “hop counter” entry is stack to the top into the signaling message; and at the load balancing terminating point, the topmost “hop counter” entry is removed from the signaling message.

### INDUSTRIAL APPLICABILITY

When a path change occurs in a network, the message identification method and the relay node used in the method according to the present invention can accurately identify the message for reserving the resources of a new path. Therefore, the message identification method and the relay node used in the method according to the present invention are effective in a message identification method and a relay node used in the method that can identify predetermined messages transmitted in accompaniment with a change in a data communication path, and the like.

1. A message identification method that, in a communication network including a second node that is a correspondent node of a first node transmitting and receiving data and a plurality of relay nodes that relay the data transmitted and received between the first node and the second node, in which a QoS reservation is made in a relay node on a data communication path between the first node and the second node, when a change occurs in a data communication path, identifies a QoS reservation message transmitted to make a QoS reservation in a relay node on a new data communication path and a QoS maintenance message transmitted to maintain the QoS reservation in the relay node on the data communication path before the occurrence of the change, the message identification method comprising the steps of:
when a relay node that has detected the change in the data communication path transmits the QoS reservation message to make the QoS reservation in the relay node on the new data communication path, including and transmitting first information used when differentiating the QoS reservation message from the QoS maintenance message; and
when the relay node that has received the QoS reservation message judges whether the relay node itself is a relay node positioned at a convergence point of the QoS maintenance message and the QoS reservation message and judges that the relay node itself is the relay node positioned at the convergence point, identifying which message is the newest, based on second information for identifying the relay node itself and the message to be received by the relay node itself, stored in a predetermined memory area of the relay node itself, and the first information included in the QoS reservation message.

2. The message identification method according to claim 1, wherein the relay node positioned at the convergence point of the QoS maintenance message and the QoS reservation message decides whether to update the stored second information based on an identification result regarding which message is the newest.

3. The message identification method according to claim 1, wherein the first information includes at least sequence information that is managed by the first node and is used to identify messages between the first node and the second node, history information that is history information of past data communication path changes, stored in the relay node that has detected the change in the data communication path, to which identification information identifying the relay node itself that has detected the change in the data communication path is added, and distance information that indicates a distance between the relay node that has detected the change in the data communication path and the first node.

4. The message identification method according to claim 1, wherein the second information includes at least distance information that indicates a distance between the relay node positioned at the convergence point of the QoS maintenance message and the QoS reservation message and the first node, sequence information that is managed by the first mode and is used to identify the messages between the first node and the second node, and history information of past data communication path changes.

5. The message identification method according to claim 3, wherein the distance information increases as every time the message is transferred.

6. The message identification method according to claim 4, wherein, when identifying which message is the newest, the relay node positioned at the convergence point of the QoS maintenance message and the QoS reservation message performs the identification based on the sequence information in the first information and the sequence information in the second information and, when the sequence information in the first information and the sequence information in the second information are the same, performs the identification based on the history information in the first information and the history information in the second information.

7. The message identification method according to claim 1, wherein the first information includes at least session identification information that identifies a communication session, flow identification information that identifies a message flow, sequence information that is managed by the first node and is used to identify messages between the first node and the second node, distance information that indicates a distance between the relay node that has detected the change in the data communication path and the first node, and information that is path change information before data communication path change, stored in a predetermined memory area of the relay node that has detected the change in the data communication path, to which path change information, including distance information indicating a distance between the relay node that has detected the change in the data communication path and the first node and information on the frequency of data communication path changes in the relay node that has detected the change in the data communication path, is added.

8. The message identification method according to claim 1, wherein the second information includes at least session identification information that identifies a communication session, flow identification information that identifies a message flow, sequence information that is managed by the first node and is used to identify messages between the first node and the second node, distance information that indicates a distance between the relay node positioned at the convergence point of the QoS maintenance message and the QoS reservation message and the first node, information on the frequency of changes in the data communication path in the relay node positioned at the convergence point of the QoS maintenance message and the QoS reservation message, and path change information that includes distance information indicating a distance between the relay node that has detected another data communication path change before the change in the data communication path and information on the frequency of changes in the data communication path in the relay node that has detected the other data communication path change before the change.

9. The message identification method according to claim 7, wherein the distance information increases ever time the message is transferred.

10. The message identification method according to claim 1, wherein, when identifying which message is the newest, the relay node that is positioned at the convergence point of the QoS maintenance message and the QoS reservation message performs the identification based on the sequence information in the first information and the sequence information in the second information and, when the sequence information in the first information and the sequence information in the second information are the same, performs the identification based on the path change information in the first information and the path change information in the second information.

11. A relay node used in a message identifying method that, in a communication network including a second node that is a correspondent node of a first node transmitting and receiving data and a plurality of relay nodes that relay the data transmitted and received between the first node and the second node, in which a QoS reservation is made in a relay node on a data communication path between the first node and the second node, when a change occurs in a data communication path, identifies a QoS reservation message transmitted to make a QoS reservation in a relay node on a new data communication path and a QoS maintenance message transmitted to maintain the QoS reservation in the relay node on the data communication path before the occurrence of the change, the relay node comprising:
a receiving means for receiving the messages;
a storing means for storing state information used to identify the relay node itself and a message to be received by the relay node itself;
a generating means for generating the QoS reservation message that is used to make the QoS reservation in the relay node on the new data communication path when a change occurs in the data communication path and includes the identification information used when differentiating the QoS reservation message from the QoS maintenance message;
a transmitting means for transmitting the generated QoS reservation message over the new data communication path;
a judging means for judging whether the relay node itself is the relay node positioned at the convergence point of the QoS maintenance message and the QoS reservation message transmitted from another relay node; and
an identification means for identifying which message is the newest based on the state information stored in the storing means and the identification information included in the QoS reservation message transmitted from the other relay node, when judged that the relay node itself is the relay node positioned at the convergence point of the QoS maintenance message and the QoS reservation message transmitted from the other relay node.

12. The relay node according to claim 11, wherein the identifying means decides whether to update the state information stored in the storing means based on an identification result.

13. The relay node according to claim 11, wherein the state information includes at least distance information that indicates a distance between the relay node itself and the first node, sequence information that is managed by the first node and is used to identify messages between the first node and the second node, and history information of past data communication path changes.

14. The relay node according to claim 13, wherein the identification information included in the QoS reservation message includes at least sequence information that is managed by the first node and is used to identify messages between the first node and the second node, history information that is the history information of the past data communication path changes included in the state information to which the identification information identifying the relay node itself is added, and distance information that indicates a distance between the relay node itself and the first node.

15. The relay node according to claim 13, wherein the distance information increases every time the message is transferred.

16. The relay node according to claim 14, wherein, when identifying which message is the newest, the identifying means performs identification based on the sequence information in the identification information included in the QoS reservation message transmitted from the other relay node and the sequence information in the state information in the storing means and, when the sequence information in the identification information included in the QoS reservation message transmitted from the other relay node and the sequence information in the state information in the storing means are the same, performs the identification based on the history information in the identification information included in the QoS reservation message transmitted from the other relay node and the history information in the state information in the storing means.

17. The relay node according to claim 11, wherein the state information includes at the least session identification information that identifies a communication session, flow identification information that identifies a message flow, sequence information that is managed by the first node and is used to identify messages between the first node and the second node, distance information that indicates a distance between the relay node itself and the first node, information on the frequency of changes in the data communication path in the relay node itself, and path change information that includes distance information indicating a distance between the relay node that has detected the other data communication path change before the change in the data communication path and the first node and information on the frequency of changes in the data communication path in the relay node that has detected the other data communication path change before the change.

18. The relay node according to claim 17, wherein the identification information included in the QoS reservation message includes at least session identification information that identifies a communication session, flow identification information that identifies a message flow, sequence information that is managed by the first node and is used to identify messages between the first node and the second node, distance information that indicates a distance between the relay node itself and the first node, and information that is the path change information before the data communication path change stored in the storing means of the relay node itself to which the path change information, including distance information indicating a distance between the relay node itself and the first node and information on the frequency of the changes in the data communication path in the relay node itself, is added.

19. The relay node according to claim 17, wherein the distance information increases every time the message is transferred.

20. The relay node according to claim 18, wherein, when identifying which message is the newest, the identifying means performs the identification based on the sequence information in the identification information included in the QoS reservation message transmitted from the other relay node and the sequence information in the state information in the storing means and, when the sequence information in the identification information included in the QoS reservation message transmitted from the other relay node and the sequence information in the state information in the storing means are the same, performs the identification based on the path change information in the identification information included in the QoS reservation message transmitted from the other relay node and the path change information in the state information in the storing means.
